(19) United States
(12) Patent Application Publication
(10) Pub. No.: US 2011/0320835 A1
(43) Pub. Date: Dec. 29, 2011

(54) SYSTEM AND METHOD FOR DYNAMICALLY MANAGING POWER IN AN ELECTRONIC DEVICE

(76) Inventor: David W. Browning, Beaverton, OR (US)

(21) Appl. No.: 12/826,303

(22) Filed: Jun. 29, 2010

(51) Int. Cl. G06F 1/32

(52) U.S. Cl. 713/320

(57) ABSTRACT

A power controller receives a status signal, generates a control signal from the status signal, and reduces an output voltage of a voltage regulator based on the power control signal. The status signal is indicative of an operating tolerance or condition of a circuit or function of an electronic device during a low power state, and the output voltage of the voltage regulator is reduced to a value that corresponds to the operating tolerance or condition of the circuit or function of the electronic device.

### FIELD

One or more embodiments described herein relate to power management.

### BACKGROUND

Power management continues to be a goal of system designers. One approach to minimizing power consumption involves changing the operating state of the system. However, even when such a state change is performed, voltage regulators (VRs) in the system are maintained at constant output voltage. Consequently, system power load remains constant even when activity of the system circuits is not constant, e.g., inactive.

### BRIEF DESCRIPTION OF THE DRAWINGS

FIG. 1 is a diagram showing an example of a device subject to power control.

FIG. 2 is a diagram showing one embodiment of a power management circuit.

FIG. 3 is a diagram showing power control in accordance with an embodiment.

FIG. 4 is a diagram of one embodiment of a power control method.

### DETAILED DESCRIPTION

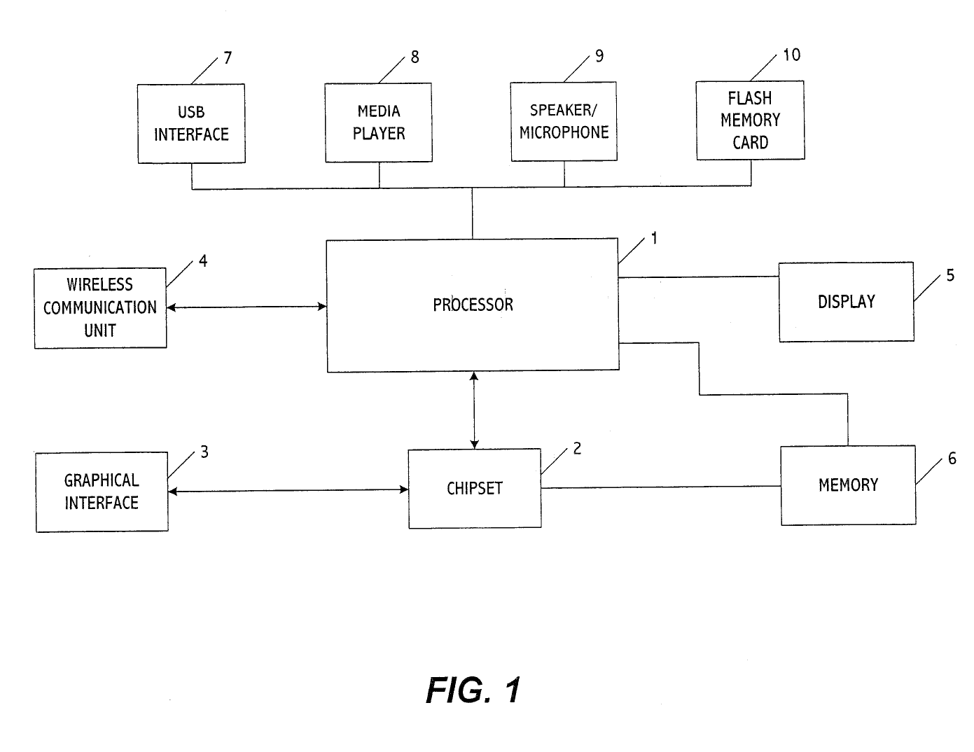

FIG. 1 shows an example of an electronic device subject to power management in accordance with one or more embodiments of the present invention. The electronic device may be any one of a number of battery-powered devices such as but not limited to a mobile phone, personal digital assistant, media player, or laptop or notebook computer. Alternatively, the device may be an AC-powered device that is usually used at a fixed location such as a desktop computer, television, DVD or other type of media player, surround-sound or other media receiver just to name a few.

As shown, the electronic device may include a processor 1, chipset 2, graphical interface 3, wireless communications unit 4, display 5, memory 6, and a plurality of functional circuits including a USB interface 7, media player 8, speaker and microphone circuits 9, and a flash memory card 10. In other embodiments, a different combination or arrangements of circuits and functions may be included.

Especially in the case wherein the electronic device is battery powered, a management scheme may be employed for purposes of saving power and increasing the operating life of the device while powered by the battery. One type of power management scheme involves setting the device in various power modes depending, for example, on the workload or activity of the device. An example of the different power modes, or power states, is set forth below:
System Power State S0 the ON state: The system is completely operation, fully powered and completely retains the context. Also called Active State.
System Power State S1 the Sleep state: The system consumes less power than S0 state. All Hardware & Processor context is maintained.
System Power State S2 the Sleep state: The system consumes less power than S1 state. Processor loses power and processor context and contents of the cache are lost.
System Power State S3 the Sleep state: The system consumes less power than S2 state. Processor & Hardware context, cache contents, and chipset context are lost. The system memory is retained.
System Power State S4 the Hibernate state: The system consumes the least power compared to all other sleep states. The system is almost at an OFF state, expect for a trickle power. The context data is written to hard drive (disk) and there is no context retained.
System Power State S5 the OFF state: The system is in a shutdown state and the system retains no context. Note that in power state S4 the system can restart from the context data stored on the disk, but in S5 the system requires a

These states may be implemented, for example, when the electronic device is a notebook computer, but the embodiments described herein are in no way to be limited to such an example. Moreover, any one or more of states S1 to S5 may be considered to be an idle or low power state, and a state of idleness may also be found within the S0 state in certain circumstances.

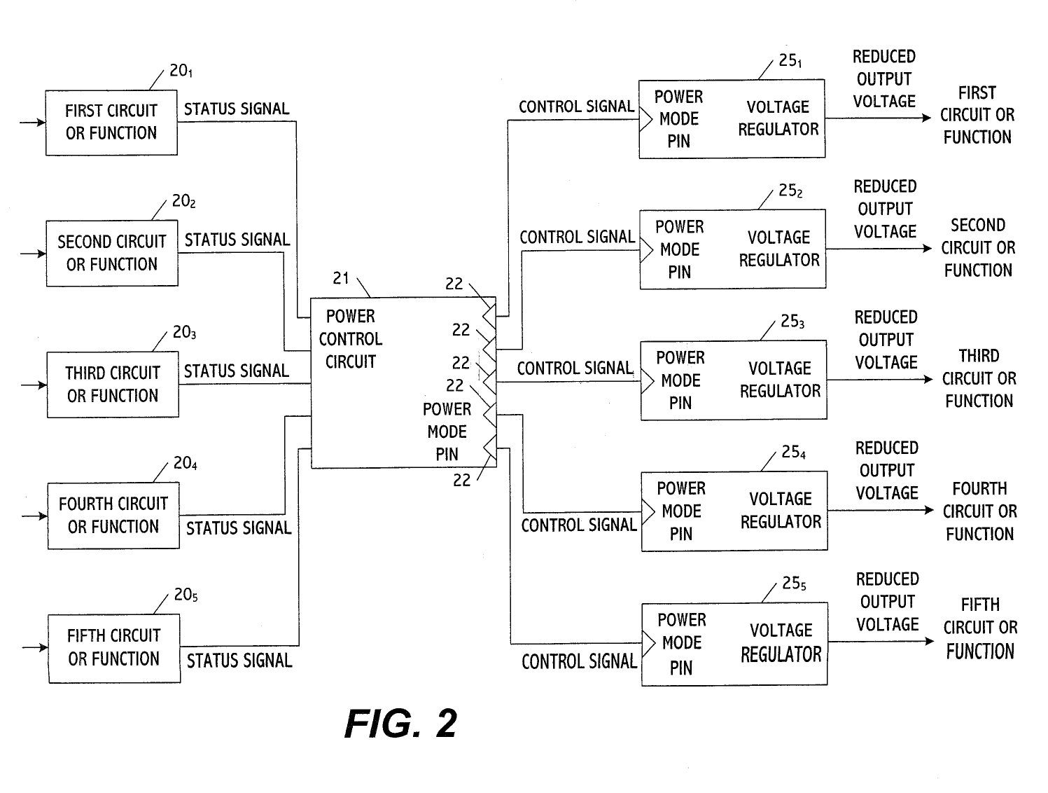

FIG. 2 shows one embodiment of a power management circuit for controlling power in an electronic device as previously described. The power management circuit includes a power control circuit 21 which may correspond to or include the processor or chipset shown in FIG. 1 or a different circuit such as but not limited to a dedicated power management circuit.

The power control circuit generates one or more control signals for controlling power to one or more circuits within or coupled to the electronic device, or for powering one or more functions to be performed within the electronic device. The control signals may be output from one or more special pins (e.g., power mode pins 22) or may be generated or otherwise derived from one or more existing pins of the power control circuit. When the power control circuit is the chipset of the device, a pre-existing pin of the chipset may be used to generate the one or more control signals.

The number of control signals to be generated may correspond to the number of circuits or functions to be controlled. To provide dynamic control, each control signal may be generated based on an operating tolerance or condition of a corresponding one of the circuits or functions. For illustrative purposes, five circuits 20₁, 20₂, 20₃, 20₄, and 20₅ are shown in FIG. 2. Accordingly, the power control circuit may generate five control signals (output from the same or different pins) to control the five circuits independently from one another, based on the specific operating conditions or tolerances of those circuits. If functions are to be controlled, the power control circuit may generate control signals to control different functions to be performed within, for, or by the electronic device.

The operating tolerances or conditions of the circuits or functions may be measured, for example, in terms of a minimum operating voltage of the circuits or functions in a predetermined state, which, for example, may correspond to any one of the low or idle states previously mentioned or a state different from a low or idle state. The circuits to be controlled (e.g., 20₁, 20₂, 20₃, 20₄, and 20₅) may be included within or coupled (e.g., as a peripheral) to the electronic device.

The control signals may be generated based on a monitoring scheme. According to this scheme, each circuit to be controlled outputs information which provides an indication of its minimum operating voltage at that time, e.g., at the time the circuit is in idle state. This information, which, for example, may be in the form of a status signal, may be output from a special pin or terminal of each circuit. Alternatively, the status signal may be derived from a signal output from an existing terminal or pin. To generate the status signal, each circuit may include a detector or software that detects the actual minimum operating voltage of the circuit (or function) when in idle state and then generates the status signal based on the detected voltage.

Alternatively, each circuit may include or be coupled to a register, memory chip, or other storage circuit that stores a predetermined minimum operating voltage value for the low power or other state. This value may be derived, for example, from a circuit data sheet provided, for example, from the circuit manufacturer. Thus, for example, when or just before the circuit enters idle state, the stored value may be output to the power control circuit for power control purposes.

Once the status signals from circuits 20₁, 20₂, 20₃, 20₄, and 20₅ are received, the power control circuit generates control signals for those circuits. This may be achieved, for example, by controlling the voltages (e.g., reference or platform voltages) output from each of a plurality of voltage regulators 25₁, 25₂, 25₃, 25₄, and 25₅, coupled to corresponding ones of the circuits. Each voltage regulator may include a power mode pin which receives a corresponding control signal from the power control circuit.

In response to the control signal (which, for example, may be information in either analog or digital form), a corresponding voltage regulator reduces or changes its output voltage based on or to match (at least substantially so) the minimum operating voltage for that circuit (or function), as determined by the status signal output from that circuit. Each voltage regulator, therefore, is independently and selectively controlled (relative to other voltage regulators) to dynamically set the power for a corresponding circuit based on the status signal output from that circuit.

Accordingly, the amount by which each voltage regulator reduces its output may differ from each other. For example, circuits 20₁ and 20₂ may require the same amount of power during an active state. However, those circuits may have different minimum operating voltages in idle state. Thus, when circuits 20₁ and 20₂ enter into idle state (which, for example, may be a same idle state or different low power states), they may output status signals to power control circuit 21 that indicate different minimum voltages. The power control circuit will then generate control signals to set voltage regulators 25₁ and 25₂ to output different voltages (or voltage ranges) based on or which match the minimum operating voltages of those circuits. In this way, circuits 20₁ and 20₂ are independently and selectively controlled, thereby resulting in power savings.

In accordance with one embodiment, each control signal may include information indicative of the amount by which each corresponding voltage regulator is to reduce its output, e.g., indicative of a minimum operating voltage of the circuit coupled to the voltage regulator.

For example, the control signal may include protocol information embedded in the signal which tells (or may be interpreted by) the voltage regulator to what extent its output voltage is to be adjusted. According to one application, the control signal may be in a format or protocol compatible with a voltage-regulator control mechanism similar to those used by a central processing unit (CPU) core, e.g., Intel's Serial VID.

Each circuit may correspond to a platform containing a plurality of devices. The platform devices may report their minimum operating voltages in status signals to the power control circuit during, for example, idle conditions. The power control circuit may then compare these minimum voltages to determine the maximum of the minimum voltages. A control signals may then be generated by and output from the power control circuit to set the voltage regulator for that platform to output the maximum voltage (i.e., the highest value of the minimum operating voltages of each respective device on the platform).

Alternatively, each circuit or platform may report their minimum operating voltages to the power control circuit during, for example, idle conditions. The maximum of these voltages may be determined and then control signals may be generated by and output from the power control circuit to set the voltage regulators to the maximum voltage to their respective circuits or platforms.

According to these techniques, none of the device minimums settings during idle are violated and at the same time significant power savings is achieved. Put differently, in accordance with one embodiment the output voltages of the voltage regulators are dynamically adjusted based on the actual operating tolerances of the circuits, devices, and/or platforms to realize improved power management.

The voltage regulators which have their output voltages reduced may include not only ones which control a main processor or central processing unit, but also ones that control other circuits including but not limited to the graphics circuits and/or any of the other circuits shown, for example, in FIG. 1 apart from the central processing unit.

For example, in one application, power platforms are provided for each of a plurality of circuits in a device and the output voltages of the voltage regulators used to power each platform are adjusted. The adjustments may be made for idles periods for these platforms within, for example, a Converged Platform Power Management (CPPM) architecture.

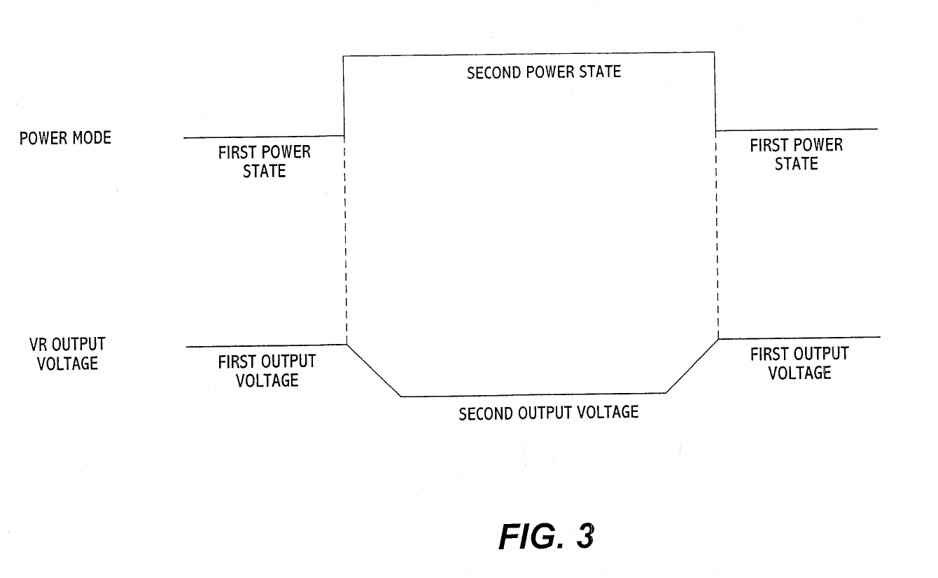

FIG. 3 shows an example of power reduction that may be realized in accordance with one or more embodiments described herein. As shown, when all or a portion of the electronic device is operating in a first power state, a voltage regulator outputs a relatively high voltage to its respective circuit or to power its respective function. When a status signal is received from this circuit or function in a second power state, the power control signal controls a corresponding voltage regulator to reduce its output voltage to a value less than the voltage output in the first power state. The first power state may an active state and the second power state may be an idle state. The output of the voltage regulator may return to the first output voltage corresponding to the first power state when another status signal is receive indicative of such a state.

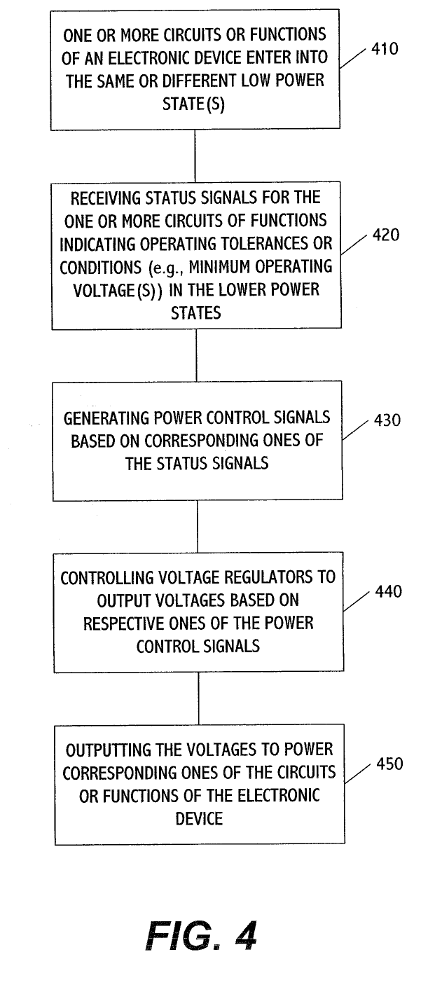

FIG. 4 shows operations included in a method for managing power in an electronic device. The method may be performed in an electronic device as shown in FIGS. 1 and 2, or in any other electronic whether portable or stationary, battery powered or AC powered.

In an initial operation, the operating system of the device issues a signal causing the device (or any function or circuit of the device) to enter into a reduced power state. (Block 410). The reduced power state may be any power state that causes the device to consume less power than in another power state. In the case where more than one circuit or function of the device enters into a reduced power state, the reduced power states of those circuits or functions may be the same or different reduces power states.

For example, in an electronic device where power states S0-S5 are observed (as previously discussed), the S0 state corresponds to an ON state and the S1 to S5 states correspond to lower power states. Thus, in accordance with the present embodiment, the reduced power state in Block 410 may be any of the S1 to S5 power states. In other devices, different power states may be used and Block 410 may therefore be performed to set the device to the same or different lower power states in an analogous manner.

The lower power state(s) may be generally considered to be one or more idle power states or S0ix states in a CPPM architecture. In the notation S0ix state, the “i” may represent an idleness period within an S0 state and the “x” may represent a placeholder for the duration of the idleness period, with larger values of “x” representing longer durations. Also, in the CPPM architecture, idle windows are created during one or more of various power states including the S0 state. This same approach to power management including the creation of idle periods and the reduction of output voltages of voltage regulators may be applied to any type of advanced platform power management technique or architecture.

In a second operation, the circuits which entered into the lower power state(s) generate status signals indicative of their operating tolerances or conditions at that time. (Block 420). As previously indicated, those conditions or tolerances may be expressed, for example, in terms of a minimum operating voltage in the lower power state(s). The status signals are sent to a power control circuit to perform power management.

In a third operation, the power control circuit generates power control signals based on corresponding ones of the status signals. (Block 430). The power control signals contain information for effecting a reduction in power to be delivered to the circuits and/or functions of the device which generated the status signals. These signals may be analog or digital in nature depending on the particular application or host electronic device.

In a fourth operation, one or more voltage regulator (and/or other types of power regulation) circuits are controlled based on respective ones of the power control signals output from the power control circuit. (Block 440). The voltage regulator circuits are controlled to reduce their output voltages based on the power control signals. This involves reducing the output voltages of the voltage regulator circuits based on or to match (at least substantially so) the operating tolerances or conditions (e.g., minimum operating voltages) indicated by respective ones of the status signals.

In a fifth operation, the reduced output voltages are used to power corresponding ones of the circuits or functions of the device in the lower power (e.g., idle) state(s). (Block 450). Through this method, the power (e.g., voltages) supplied to different circuits or function of the device is therefore independently and separately controlled to achieve power savings, based on the operating tolerances or requirements unique to each of those circuits or functions. Through this control, each circuit or function may be set to different operating voltages or to within different voltage ranges based on the operating tolerances and/or conditions indicated by the status signals.

The output voltage reduction of each regulator may be performed in various ways. For example, if the voltage regulator includes a phase-locked loop (PLL) circuit with a voltage-controlled oscillator (VCO) circuit, the input reference signal into a phase/voltage comparator circuit of the PLL may be changed to a lower or different value. This will case the output voltage of the VCO to lower by a proportional amount. By selectively controlling the output voltage of each voltage regulator in this manner, the overall amount of power consumed by the electronic device may be lowered significantly.

In accordance with one or more embodiments herein, each circuit or platform may output one or more status signals to the power control circuit. Each status signal may be binary in nature or may be a multi-bit signal carried along one or more signal lines. Likewise, the power control circuit may output one or more control signals to each of the voltage regulators, where the control signals include the protocol and/or other information previously described identifying the and may be a multi-bit signal. For both the status and control signals, the multi-bit signals may be sent serially along a single line or in parallel along multiple signal lines.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although embodiments of the present invention have been described herein with reference to a number of illustrative embodiments, it should be understood that numerous other modifications and embodiments can be devised by those skilled in the art that will fall within the spirit and scope of the principles of the embodiments of the invention. More particularly, reasonable variations and modifications are possible in the component parts and/or arrangements of the subject combination arrangement within the scope of the foregoing disclosure, the drawings and the appended claims without departing from the spirit of the embodiments of the invention. In addition to variations and modifications in the component parts and/or arrangements, alternative uses will also be apparent to those skilled in the art.

We claim:

1. An electronic device comprising:
a power control circuit to generate one or more control signals based on one or more status signals; and
a voltage regulator to reduce an output voltage based on the one or more control signals, wherein the output voltage is to be reduced to a value that corresponds to an operating tolerance of a circuit or function of the electronic device when the circuit or function is in a low power state, and wherein the one or more status signals are to be indicative of the operating tolerance in the low power state.

2. The electronic device of claim 1, wherein the output voltage of the voltage regulator is to be reduced during an idle state in response to the one or more control signals.

3. The electronic device of claim 1, wherein the operating tolerance corresponds to a minimum operating voltage of the circuit or function in the low power state.

4. The electronic device of claim 1, wherein the low power state is a power state lower than an active state.

5. The electronic device of claim 4, wherein the low power state is an idle state.

6. The electronic device of claim 1, wherein the power control circuit is to be coupled to receive the one or more status signals from the circuit or function of the electronic device, the circuit or function to also receive the output voltage of the voltage regulator.

7. The electronic device of claim 1, wherein the power control circuit is to generate a plurality of control signals based on a respective plurality of status signals, each of the status signals to indicate an operating tolerance of a different circuit or function of the electronic device in the low power state.

8. The electronic device of claim 7, wherein the control signals are to independently reduce output voltages of corresponding ones of a plurality of voltage regulators.

9. The electronic device of claim 8, wherein:
the operating tolerances of at least two of the circuits or functions are to be different, and
the control signals are to set output voltages of corresponding ones of the voltage regulators to different values or ranges based on the different operating tolerances.

10. The electronic device of claim 1, wherein the one or more status signals correspond to a multi-bit signal carried along one or more signal lines.

11. A power control method comprising:
receiving one or more status signals;
generating one or more control signals from the one or more status signals; and
reducing an output voltage of a voltage regulator based on the one or more control signals, wherein the one or more status signals are to be indicative of an operating tolerance of a circuit or function of an electronic device during a low power state, and wherein the output voltage of the voltage regulator is to reduce a value that corresponds to the operating tolerance of the circuit or function of the electronic device.

12. The method of claim 11, wherein the operating tolerance is to correspond to a minimum operating voltage of the circuit or function in the low power state.

13. The method of claim 10, further comprising:
receiving a plurality of status signals; and
generating a plurality of control signals based on respective ones of the status signals,
wherein the status signals are to indicate operating tolerances of different circuits or functions of the electronic device when the different circuits or functions are in a same low power state or in different low power states.

15. The method of claim 14, wherein the control signals are to independently reduce output voltages of corresponding ones of a plurality of voltage regulators, and wherein the plurality of voltage regulators are respectively coupled to the different circuits or functions of the electronic device.

16. A power controller comprising:
a power control circuit to receive one or more status signals and to generate one or more control signals based on the one or more status signals, wherein:
the one or more status signals are to provide an indication of an operating tolerance of a first circuit coupled to the power control circuit when the first circuit is in a low power state, and
the power control circuit is to be coupled to control an operating voltage of the first circuit based on the one or more control signals.

17. The power controller of claim 16, wherein the power control circuit is to:
receive a first status signal and a second status signal, wherein:
(a) the first status signal is to provide an indication of an operating tolerance of the first circuit while in a first low power state and the second status signal is to provide an indication of an operating tolerance of a second circuit while in a second lower power state, and
(b) the operating tolerance of the first circuit is to be different from an operating tolerance of the second circuit, and
generate first and second control signals based on respective ones of the first and second status signals, the first and second control signals to independently control operating voltages of corresponding ones the first and second circuits.

18. The power controller of claim 17, wherein the first low power state is to be different from the second low power state.

19. The power controller of claim 18, wherein the power control circuit is to receive the first and second status signals through different pins or terminals and is to output the first and second control signals through different pins or terminals.

20. The power controller of claim 16, wherein the one or more control signals include information instructing a voltage regulator to reduce the operating voltage by certain amount.
